(19) United States
(12) Patent Application Publication
(10) Pub. No.: US 2011/0264502 A1
(43) Pub. Date: Oct. 27, 2011

(54) TRANSACTIONAL APPARATUS

(76) Inventors: Greg Taylor, Sydney (AU); Joan Nelson, Sydney (AU)

(21) Appl. No.: 13/126,810

(22) PCT Filed: Oct. 30, 2009
(86) PCT No.: PCT/GB09/02583

§ 371 Date: Jun. 24, 2011

(30) Foreign Application Priority Data
Oct. 30, 2008 (GB) 0819934.1

(51) Int. Cl. G06Q 30/00; G06K 5/00

(52) U.S. Cl. 705/14.25; 235/380

(57) ABSTRACT

A transactional apparatus for providing user identification such as a purchaser of goods or services at a Point of Sale (POS) with a reward, or providing an identity transaction of a user in say a Post Office or retailer of postal services. The apparatus comprises a device (1) remote from the POS adapted to capture and derive transactional information data relating to the user whereby to provide user identification based on the transactional information data.

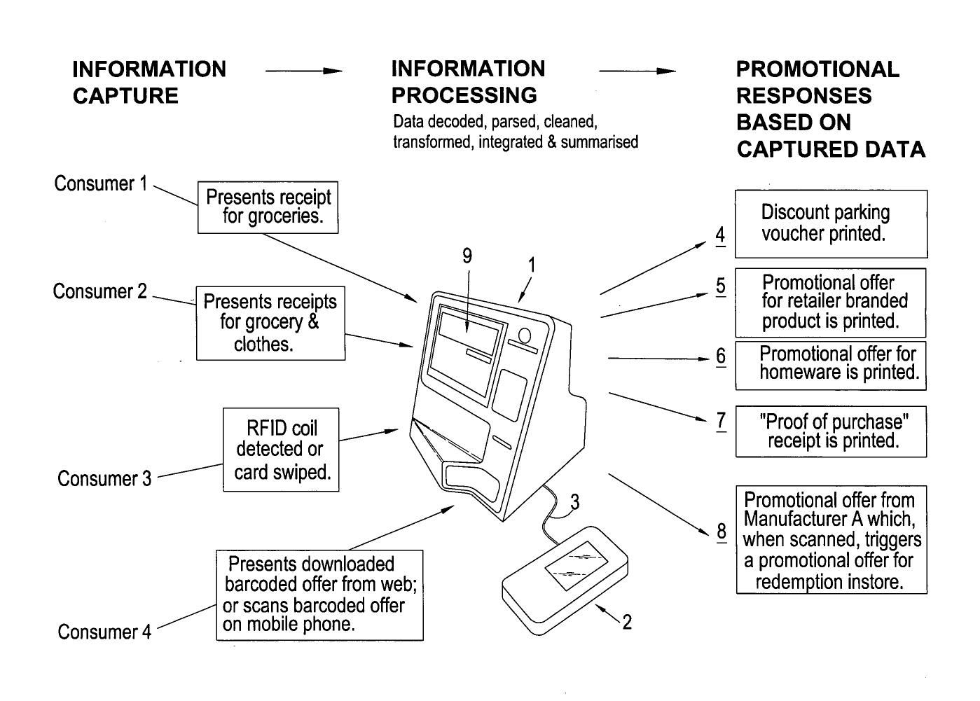

The invention relates to transactional apparatus, and particularly to such apparatus for providing user identification such as a purchaser of goods or services at a Point of Sale (POS) with a reward, or providing an identity transaction of a user in say a Post Office or retailer of postal services.

It is to be understood that the term “reward” used herein in relation to purchasers of goods or services comprises any loyalty program reward, promotional offer, prize, discount, parking fee reduction or the like which is offered to a purchaser (user of the apparatus) based on his or her transactional data at a POS.

Moreover, the POS may be in a shop, retail outlet, wholesale outlet, casino, terminal such as a bus, railway, ferry or airport terminal, at a provider of facilities such as leisure e.g. a fitness centre, swimming pool, aerobics class, theatre or the like, or the payment of a service such as provided by a utility.

In order to exemplify the invention, reference is first had to current reward systems.

Currently promotional programs are conducted by retailers which utilise transactional data obtained at point-of-sale (POS). This transactional data is typically obtained by scanning a unique product code (UPC) via the POS terminal. It is then used to ‘trigger’ promotional offers conditional upon particular products appearing in the consumer's purchase (or transaction) ‘basket’.

A key advantage of using transactional data, captured at point-of-sale, for this purpose is the ability to make promotional offers which directly relate to a consumer's purchase basket. For example, consumer goods manufacturers are able to make offers for the purpose of inducing a consumer to switch from a competitor's brand (purchased on this occasion) to their brand (purchased on a subsequent occasion in conjunction with the redemption of a promotional offer).

These promotional programs may be augmented by a loyalty card, which individually identifies the consumer, allowing for a points-based loyalty scheme or other rewards based upon the consumer's expenditure patterns at the store.

The use of transactional data, captured at point-of-sale, can significantly improve the efficiency of consumer promotional activities (they have a higher response rate than would otherwise be the case). However, the cost of implementing these programs can be significant. New hardware may be required at each checkout lane (e.g. a dedicated promotional print, scanner, etc), as well as new software systems (e.g., to capture the transactional data, identify the consumer, identify trigger purchases, publish the appropriate promotional offer, database systems to store an individual consumer's historical transaction data, etc). The associated costs can increase significantly where ‘legacy’ POS and other operational systems need to adapted or retrofitted with the capability to capture and utilize this transactional data for promotional purposes. Further, where older legacy systems are involved, there exists a key business risk for the retailer. Any malfunctioning of the POS or other core operating systems resulting from their modification, in order to accommodate a promotional system linked to POS data may lead to operational disruption, potentially dissatisfied customers and even lost sales. For retailers with existing legacy systems the cost of upgrading their POS equipment and potentially their core operating systems may not be cost-justifiable solely to deploy a consumer promotional program linked to POS data. The potential cost and complexity is further exacerbated where unrelated co-located retailers (e.g. tenant retailers within a mall), or related retail outlets with different systems wish to work co-operatively to utilise their combined transactional data (captured across different and multiple outlets) in order to make targeted offers and communicate targeted messages, in a way that benefits each participating retailer.

It is an object of the invention to seek to mitigate these disadvantages.

According to the invention, there is provided apparatus for providing user identification associated with a Point of Sale (POS), comprising a device remote from the POS adapted to capture and derive transactional information data relating to the user whereby to provide user identification based on the transactional information data.

Using the invention, since the device is remote from the POS (by ‘remote’ being meant that it is not operatively connected thereto and may be positioned at a location separate from the POS, for example at an exit of a store or mall), a purchaser/customer is encouraged into the habit of obtaining the reward himself or herself, after carrying out a transaction at one or more POS.

The device may comprise a stand-alone device for processing the transactional information data and a scanner. Thus the device may comprise a kiosk.

Suitably the said device and scanner may be integral. This provides a compact construction, though the device and scanner may be separate items connected electrically, or electronically e.g. by a wireless connection.

Suitably, the scanner may comprise an OCR scanner.

The scanner may alternatively comprise a web cam device.

The device may comprise a touch screen.

The apparatus may comprise OCR software adapted for decoding the transactional information data and provide a reward to a user, suitably the reward may comprise a message on the touch screen, or a coupon printed by the device.

The coupon may be readable by a suitably programmed POS to process the reward.

The device may suitably be adapted to provide an identity transaction of a user of the apparatus.

The device/kiosk may comprise an interactive touch screen for providing a scanning sequence using the scanner to provide user identification.

The apparatus may also be adapted to provide a verified user identification means, for example a bar-coded means or a printed copy of a scanned user identification document or documents.

The apparatus in a particular application may comprise a postal device for receiving mail from a verified user.

The mail may be selected from the group comprising parcels, packages and the like, and the postal device may comprise a drop-off box which may suitably be positioned adjacent the device.

The postal device may also comprise means for weighing and/or dimensioning mail.

Apparatus embodying the invention is hereinafter described, by way of example, with reference to the accompanying drawing, which shows a schematic perspective view of the apparatus used in conjunction with purchase of goods or services.

Referring to the drawing, there is shown apparatus for providing a purchaser of goods or services associated with a Point of Sale (POS), (not shown) comprising a device 1 remote from the POS adapted to capture and derive transactional information data generated at the POS whereby to provide a reward based on the transactional information data.

The device 1 is a stand-alone device for processing the transactional information data and a scanner 2.

The scanner 2 in the embodiment shown is a separate OCR scanner which is connected by connection means 3 to the device 1 electrically or electronically, e.g. by a wireless connection. It can alternatively be incorporated as an integral part of the device, which saves space.

The device 1 is in the embodiment a stand-alone kiosk positioned for example at an exit of a retail outlet, shopping mall or the like and to which a customer voluntarily goes after making a purchase at a POS in order to claim a reward or identification verification. The device 1 is an information processing device at which transactional data is in a preferred embodiment decoded, parsed, cleaned, transformed, integrated and utilised for the estimation of analytic models (e.g. for prediction and classification) using appropriate software, which again in a preferred embodiment is customised for the particular application.

The kiosk can be used for providing a reward from a variety of individual customers, identified by way of example as customer 1, customer 2, customer 3 and customer 4 in the FIGURE, though it will be appreciated that there may well be more, or fewer, than four customers/users of the apparatus.

Customer 1 presents a receipt from a POS, customer 2 presents a plurality of receipts for example, groceries and clothes, customer 3 presents an ID card (RFID coil detected or card swiped) and customer 4 presents a downloaded bar coded offer from the web, or scans a bar-coded offer on a mobile phone or other device such as a PALM.

Any such offers can, it will be understood, be made by manufacturers (or their sales, advertising or marketing agents) and published online, via mobile ‘phone, other mobile devices such as PALM, or distributed by newspaper, magazines or direct mail.

The kiosk 1, on receiving the transactional data, provides promotional responses (rewards) based on the captured data, for example a discount parking voucher 4 can be printed, a promotional offer 5 related to a retailer branded product is printed, a promotional offer 6 for home ware is printed, a proof of purchase receipt 7s is printed, or a promotional offer 8 is generated from a particular manufacturer, manufacturer A, which, when scanned, “triggers” a promotional offer for redemption in say a retail outlet (store).

The kiosk has a touch screen 9 for taking a customer/user through various steps to provide a promotional response.

In a preferred embodiment, the invention described herein with reference to the drawing is used as follows:
1. Consumers visiting a retailer or mall are invited to register their receipts at a self service kiosk located at the exit/s of the store or mall,
2. Their individual identity may be recognized by swiping a card or scanning an identifier, carrying an RFID readable tag or using some other means of individual identification,
3. Consumers are invited to place their docket (POS) receipt/s under an optical scanning device, housed within the kiosk,
4. A touchscreen (linked to a PC internally of the kiosk) can be used to capture the customers contact details (e.g. email address, street address, mobile phone numbers)
5. An image of the receipt is captured by the optical scanner
6. OCR software is used to decode, from the text of the receipt: the specific items purchased, their price, time and date of the transaction, retailer store (where the system is deployed in a mall), total price paid, method of payment.
7. Consumers may then be presented with a message (appearing on the screen) or a printed coupon which has been conditioned on their purchase behaviour. For example, this may be a promotional offer to return to one of the stores where they made a purchase on their last visit, an offer from a retail store they have not visited, or discount voucher which reduces their parking fees (based on their total spend on that shopping trip).
8. When presented at the checkout, the coupon is scanned and provided the POS has been programmed to recognise the barcode, the transaction is processed.

The invention as hereinbefore described with reference to the drawing is able to provide the following benefits:
Lower cost and operational risk. Programs involving promotional offers and loyalty rewards can be behaviourally targeted using transaction data, without the need to upgrade POS equipment or modify core operating systems. The deployment costs for a retailer or mall owner/manager are thus very significantly reduced.
Ability to capture data on customer purchasing behaviour with competitor retailers or shopping malls. Consumers may receive an incentive to scan dockets from competitive retail stores, which help to build a complete picture of the consumer's expenditure and purchasing profile (across all retail outlets where the customer shops). In addition to improved behavioural targeting, this can reduce market research costs. Importantly, this also enables retailer promotional programs designed to switch consumers away from competitors and consolidate their customers' spend with them.
Different retailers can undertake joint, co-operative promotional programs. In a multi-store environment (e.g. a mall) with at least two co-located, unrelated retailers, consumers can scan all of their receipts, collected from each of the stores where they made purchases during a particular visit. Transactions patterns from one retailer can be used to make targeted offers for a second (for example, consumers purchasing a Fitness magazine may be presented with an introductory gym membership offer).
Programs offering rewards and discounts linked to a consumer's total expenditure can be easily implemented. For example, a consumer visiting a mall who scans all of their receipts can be issued with a discount parking voucher, where the level of discount provided is conditioned on the total spend per trip.
Suppliers to retailers can use the system to “convert” offers made via the web, direct mail, newspaper or mobile phone into a standardized format for redemption within the retail outlet. This allows the offer to be converted into a format which enables in-store redemption, while tracking the time, location and other characteristics of the redemption at the kiosk.
Promotional offers, conditioned upon transactional data, can be displayed on screen and issued to the consumer as a printed ‘coupon’, or published to a hand held communication device or email address.
Suppliers to retailers can use the system for ‘proof of purchase’. For example, once the receipt has been scanned, a special ticket (with a unique identifier) can be printed which consumers can return to the manufacturer (e.g. entering the special identifier code online, or returning the proof of purchase tickets via mail). This verifies the purchase(s) and qualifies the consumer for rewards such as gift with purchase or ‘a chance to win’.
Suppliers to retailer can use the system for ‘chance to win’ promotions, where once the consumer purchase is verified, a random (or pseudo random) number generator is used to select a ‘winning’ consumer.
Safeguards can be built into the system preventing receipts from being presented twice (given receipts can be identified according to the retailer, items purchased, time/date of transaction, duplicate registering of the receipt can be prevented).
The transaction data captured from scanning the receipt can be used for creating predictive analytic algorithms. These algorithms may be designed to maximise the redemption rate for promotional offers designed to:
   Increase spend per visit,
   Switch customers from band a to brand B
   Initiate trial of new products, existing products or services.
Retailers can improve the processing of ‘service’ transactions (e.g. bill payment, ‘recharging’ mobile phone pre-paid cards). This allows retailers to introduce new services that would otherwise be disruptive because they are longer and more complicated transactions for staff to process (e.g. identity services to verify a person's identity for the purpose of opening a bank account or proving they are over the legal age to purchase alcohol). Importantly, all the of the purchasing and transaction data, regardless of whether it relates to the purchase of a product or service, can be ‘tied together’ and linked to an individual or individual identifier.
Retailers and suppliers can exploit the captured transactional data to selectively invite consumers to participate in market research activities (e.g. consumers who purchase a particular brand or products are invited to participate in a focus group, or to respond to a survey)

For Postal authorities and retailers of postal services, the apparatus can be used to improve the efficiency of identity transactions. An off-the-shelf package can be added to a self service kiosk to allow for at least partial customer self service. There are a number of ways this technology can be deployed instore, e.g.
1. Customers wishing to perform Identity transactions are directed to a self service kiosk,
2. Using the interactive touchscreen, they are ‘stepped’ through the scanning of each of their ID documents (e.g. passport, license)
3. All of their scanned documents are captured as images (for subsequent verification), together with the required data fields,
4. The customer then presents to counter staff either: the bar-coded slip (used to search a database of scanned images) or a printed copy of the scanned documents,
5. Counter staff verify the photo ID matches the customer and finalises the transaction.

There may be other operational benefits which can accrue for Postal Authorities, such as ensuring the accuracy of data captured from passports and drivers licenses (which could be electronically verified with the relevant authorities).

Additionally, the system can be used for self-service parcel lodgement.

A ‘drop box’ can be positioned alongside the kiosk, together with off the shelf products for dimensioning and weighing packages. This allows the lodgement of parcels at the self-service kiosk.

It will be understood that the expression ‘information data’ used herein includes both information generally, and particular data.

1. Apparatus for providing user identification associated with a Point of Sale (POS), comprising a device remote from the POS adapted to capture and derive transactional information data relating to the user whereby to provide user identification based on the transactional information data.

2. Apparatus according to claim 1, the device comprising a stand-alone device for processing the transactional information data and a scanner.

3. Apparatus according to claim 2, the device comprising a kiosk.

4. Apparatus according to claim 3, the said device and scanner being integral.

5. Apparatus according to claim 4, the scanner comprising an OCR scanner.

6. Apparatus according to claim 4, the scanner comprising a web cam device.

7. Apparatus according to claim 1, the device comprising a touch screen.

8. Apparatus according to claim 7, comprising OCR software adapted for decoding the transactional information data and provide a reward to a user.

9. Apparatus according to claim 8, the reward comprising a message on the touch screen.

10. Apparatus according to claim 8, the reward comprising a coupon printed by the device.

11. Apparatus according to claim 10, the coupon being readable by a suitably programmed POS to process the reward.

12. Apparatus according to claim 3, the device being adapted to provide an identity transaction of a user of the apparatus.

13. Apparatus according to claim 12, the kiosk comprising an interactive touch screen for providing a scanning sequence using the scanner to provide user identification.

14. Apparatus according to claim 13, adapted to provide a verified user identification means.

15. Apparatus according to claim 14, the means comprising a bar-coded means.

16. Apparatus according to claim 14, the means comprising a printed copy of a scanned user identification document or documents.

17. Apparatus according to claim 14, and a postal device for receiving mail from a verified user.

18. Apparatus according to claim 1, the mail being selected from the group comprising parcels, packages and the like and the postal device comprising a drop-off box.

19. Apparatus according to claim 17, the drop-off box being adjacent the device.

20. Apparatus according to claim 17, comprising means for weighing and/or dimensioning mail.

21-22. (canceled)
